(19) United States
(12) Patent Application Publication
(10) Pub. No.: US 2005/0241517 A1
(43) Pub. Date: Nov. 3, 2005

(54) Method and apparatus for providing and transferring cassettes for printing plates

(75) Inventors: Axel Trilk, Kiel (DE); Lars Paulsen, Hollingstedt (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/116,709

(22) Filed: Apr. 28, 2005

(30) Foreign Application Priority Data
Apr. 28, 2004 (DE) 10 2004 020 693.7

(51) Int. Cl. B41L 47/14

(52) U.S. Cl. 101/477

(57) ABSTRACT

A method and an apparatus provide and transfer cassettes for printing plates to a device for removing printing plates from a cassette. The cassettes are stored in compartments disposed above one another in a magazine and are introduced into the magazine and removed through a loading opening. The cassettes are transferred to the device for removing printing plates through a transfer opening and are taken back from there. The cassettes are moved in a horizontal movement plane between the loading opening and the magazine and between the transfer opening and the magazine. The loading opening, the transfer opening and the movement plane are located at the same height. The magazine is raised and lowered vertically as desired. The cassettes are moved by a friction drive disposed in the movement plane. The activation of the friction drive releases a spring force brake, which blocks the cassettes.

### BACKGROUND OF THE INVENTION

Field of the Invention

The invention relates to the field of electronic reproduction technology and relates to an apparatus for providing and transferring cassettes for printing plates, preferably into a loading device, with which the printing plates are removed automatically from a cassette and are supplied to a printing plate exposer, which then records a printing original on the printing plate.

In reproduction technology, printing originals for printed pages that contain all the elements to be printed such as texts, graphics and images are produced. For color printing, a separate printing original is produced for each printing ink and contains all the elements that are printed in the respective color. For four-color printing, these are the printing inks cyan (C), magenta (M), yellow (Y) and black (K). The printing originals separated in accordance with printing inks are also referred to as color separations. The printing originals are generally scanned and, by using an exposer, are exposed onto films, with which printing plates for printing large editions are then produced. Alternatively, the printing originals can also be exposed directly onto printing plates in special exposure devices, or they are transferred directly as digital data to a digital press. There, the printing-original data is then exposed onto printing plates, for example with an exposing unit integrated into the press, before the printing of the edition begins immediately thereafter. In the recording devices which are used in electronic production technology for the exposure of printing originals and printing forms, an exposure beam is generated, for example a laser beam is generated by a laser diode, shaped by optical devices and focused onto the recording material and deflected over the recording material point by point and line by line by a deflection system. In order to increase the speed of the exposure, a bundle of laser beams can also be generated and, each time the printing plate is swept over, a plurality of image lines is exposed simultaneously. The recording material can be located on an exposer drum (external drum exposer), in a cylindrical hollow (internal drum exposer) or on a flat surface (flatbed exposer). For example, in the case of an external drum exposer, the printing plate to be exposed is mounted on a rotatably mounted exposure drum. As the exposure drum rotates, an exposure head is moved axially along the drum over a relatively short distance. The exposure head focuses one or more laser beams onto the drum surface, which sweep over the drum surface in the form of a narrow helix. In this way, one or more image lines are exposed during each drum revolution.

A printing plate to be exposed can be supplied manually to the printing plate exposer. It is then drawn in by the printing plate exposer and automatically clamped onto the exposure drum, where it is fixed during the exposure by clamping devices and possibly by a vacuum device. However, in order to automate the working sequence and, as a result, to save an operator, use is also made of loading devices which remove the printing plates to be exposed individually from a cassette, for example with a suction device, and supply them to the printing plate exposer. Such a loading device is described in published, non-prosecuted German patent application DE 101 34 151 A1. It will be referred to as a single-cassette loader in the following text, since it contains only one cassette in each case and removes the printing plate therefrom. The cassette contains a supply of unexposed printing plates, the printing plates as a rule all having the same format, that is to say the same dimensions. In the cassette, the printing plates are protected against dust and against the incidence of light, so the inadvertent exposure of the printing plates is prevented.

For an automated production sequence of the printing plate exposure, there is additionally the need also to supply the printing plate exposer with printing plates of different formats, which are taken from different cassettes. In an automatically proceeding unmonitored working shift, it is also possible that the number of printing plates stored in a cassette is insufficient for the duration of the shift, so that it becomes necessary also to be able to fall back on a plurality of cassettes which contain the same printing plate format.

In U.S. Pat. No. 5,655,452 A1, a loading device for printing plates is disclosed in which a plurality of cassettes can be kept in store. The individual cassettes are located on tables that are disposed one above another and can be positioned vertically. The tables are initially positioned vertically as an entire group so that a desired cassette is in a position in which a printing plate can be removed from the cassette. In order to create the necessary space for a removal device, the tables located above the desired cassette are moved further upward as a subgroup. The removal device is then placed over the desired cassette and a printing plate is removed and transferred to the printing plate exposer. The need to be able to vertically position both all the tables together and any desired subgroup of the tables separately necessitates a high level of mechanical complexity for this positioning device.

Published, European patent application EP 1 273 964 A1 (corresponding to U.S. Pat. No. 6,739,261) discloses a loading device for printing plates in which a plurality of cassettes are disposed above one another. Furthermore, there is a plate removal and transport unit having suction cups. After a desired cassette has been selected, the cassettes located above it are moved horizontally into a diversion chamber, so that the plate removal unit can be lowered onto the selected cassette and the printing plate can be removed. The printing plate removed is attracted by suction at one end, is lifted and, during the transport to the printing plate exposer, is opened up like a page of a book, being rotated through 180°. The selected cassette is moved neither vertically nor horizontally for the removal operation. The loading device also requires a high level of mechanical complexity for the selective horizontal movement of the individual cassettes and for the vertical positioning of the plate removal unit.

U.S. Pat. No. 6,422,801 B1 describes a loading device for printing plates in which a plurality of cassettes are disposed one above another but offset horizontally like a staircase. As a result, at least a subregion of each cassette is accessible from above, so that a movable arm that is provided with a suction device at its end can be lowered onto the printing plate stack in the respective cassette in this subregion. With the aid of the suction device, the arm lifts the topmost printing plate in a selected cassette, then pulls it laterally out of the cassette and transports it to the printing plate exposer. In this loading device, a complex mechanism is needed to move the removal arm.

A printing plate exposer having an integrated plate loading unit is proposed in U.S. Pat. No. 6,456,366 B1. A plurality of cassettes filled with printing plates are set up obliquely at an angle of almost 90°, with a distance between the cassettes which is sufficient to move a suction device of a plate removal unit between the cassettes. The plate removal unit, which is positioned above the selected cassette, separates the printing plate from the supply stack in this cassette by using the suction device and pulls it upward between the upright cassettes. Using a deflection device, which is likewise positioned above the selected cassette, the printing plate removed is then deflected downward and moved onto a transport path that supplies it to the exposure drum of the printing plate exposer.

The known loading devices for printing plates which are able to remove the printing plates from a plurality of cassettes, are of a relatively complicated construction and thus expensive to produce. In addition, they are not compatible with a single-cassette loader of the type described previously, in the sense that optionally only the single-cassette loader is used for the automated loading of printing plates into the printing plate exposer, or else an apparatus for providing a plurality of cassettes is used in conjunction with the single-cassette loader in order to increase the level of automation of the production sequence further.

### SUMMARY OF THE INVENTION

It is accordingly an object of the invention to provide a method and an apparatus for providing and transferring cassettes for printing plates which overcomes the above-mentioned disadvantages of the prior art methods and devices of this general type, which has a simple and economical mechanical construction. From the point of view of the method, it is an object of the invention to transfer a selected cassette automatically to a single-cassette loader, which then removes a printing plate from the cassette and supplies it to a printing plate exposer. In order to distinguish it clearly from a single-cassette loader, the apparatus according to the invention for holding a plurality of cassettes will be designated a multi-cassette loader in the following text.

With the foregoing and other objects in view there is provided, in accordance with the invention, a method for providing and transferring cassettes for printing plates to a device for removing the printing plates from a respective cassette. The method includes storing the cassettes in compartments disposed above one another in a magazine, introducing and removing the cassettes into the magazine through a loading opening, and transferring the cassettes to the device for removing the printing plates through a transfer opening and being taken aback from there through the transfer opening. The cassettes are moved in a horizontal movement plane between the loading opening and the magazine and between the transfer opening and the magazine. The loading opening, the transfer opening and the horizontal movement plane are disposed at a same height. The magazine is vertically raised and/or lowered until a desired cassette is in the horizontal movement plane.

The object is achieved by a multi-cassette loader that has a magazine with a number of compartments disposed one above another for holding one cassette in each case. The magazine can be positioned vertically as a whole within the multi-cassette loader until a selected cassette is located at the level of a transfer opening, which is immediately adjoined by the loading opening of a single-cassette loader. By a friction drive, the cassette can then be pushed horizontally out of the transfer opening and into the single-cassette loader, by which it is transferred to the single-cassette loader.

Other features which are considered as characteristic for the invention are set forth in the appended claims.

Although the invention is illustrated and described herein as embodied in a method and an apparatus for providing and transferring cassettes for printing plates, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side view of a plate loading system having a multi-cassette loader and a single-cassette loader;

FIG. 2 is a diagrammatic, front view of a magazine of the multi-cassette loader;

FIGS. 3A and 3B are diagrammatic, side views showing the loading of a cassette into the multi-cassette loader;

FIG. 4 is a diagrammatic, side view of a transfer of the cassette into the single-cassette loader;

FIG. 5 is a diagrammatic illustration of a friction drive; and

FIGS. 6A and 6B are diagrammatic, side views showing the actuation of a spring force brake.

### DESCRIPTION OF THE PREFERRED EMBODIMENTS

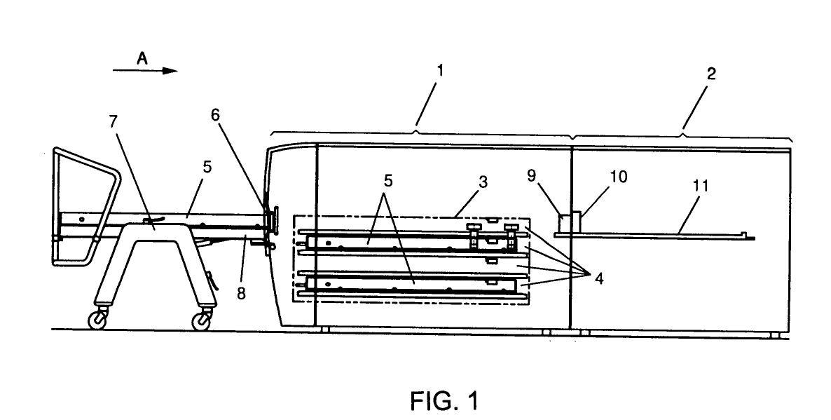

Referring now to the figures of the drawing in detail and first, particularly, to FIG. 1 thereof, there is shown a side view of a plate loading system containing a multi-cassette loader 1 and a single-cassette loader 2, which are placed immediately adjacent each other. The multi-cassette loader 1 contains a magazine 3 having a plurality of compartments 4 which are disposed one above another and which can hold a cassette 5 for printing plates each lying horizontally. The cassettes 5 can be pushed into the compartments 4 and removed from them via a loading opening 6 of the multi-cassette loader 1. For this purpose, the magazine 3 is previously moved vertically until the desired compartment 4 is located at the level of the loading opening 6. For easier handling of the relatively heavy cassettes 5, use is made of a transport trolley 7, with which a cassette can be brought up to the loading opening 6. The transport trolley 7 has a transport table 8 for this purpose, on which the cassette 5 lies. Opposite the loading opening 6 in the multi-cassette loader 1 there is a transfer opening 9, which directly adjoins a loading opening 10 of the single-cassette loader 2. Through the transfer opening 9, a cassette 5 can be transferred from the multi-cassette loader 1 to the single-cassette loader 2, where it is held by a holding table 11. For this purpose, the magazine 3 is previously positioned in such a way that the desired cassette 5 is located at the level of the transfer opening 9. Likewise, the cassette 5 from the single-cassette loader 2 can also be accepted into a compartment 4 of the multi-cassette loader 1 through the transfer opening 9. The transport table 8, the loading opening 6 of the multi-cassette loader 1, the transfer opening 9 and the loading opening 10 of the single-cassette loader 2 are advantageously all at the same height. This makes it possible to operate the single-cassette loader 2 without a multi-cassette loader 1 connected in front as well, since the transport trolley 7 can be used in the case of the manual loading of a cassette 5 directly into the single-cassette loader 2. For the purpose of improved clarity, FIG. 1 shows no further details of the single-cassette loader.

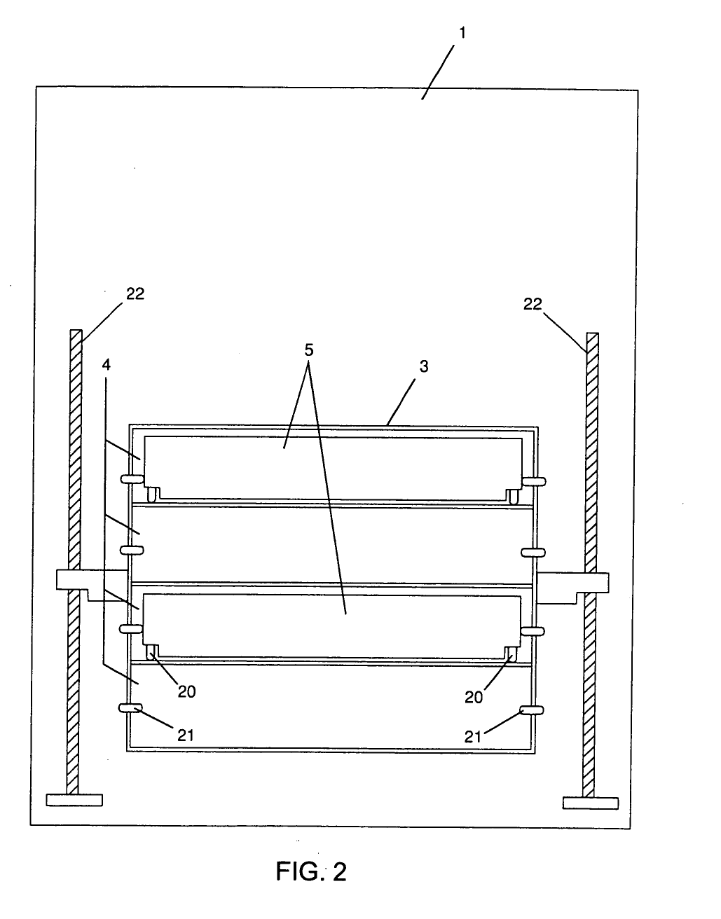

FIG. 2 shows a view from in front, that is to say in the direction of the arrow A, in a simplified illustration of the magazine 3 of the multi-cassette loader 1. The magazine 3 is divided into four compartments 4 in this example. The cassettes 5 are shown in two compartments 4, the other two compartments 4 are empty. The cassettes 5 have running rollers 20, with which they run on compartment bases and can thus be moved easily. In addition, guide rollers 21 are provided in the side walls of the magazine 3 and guide the side walls of the cassettes 5, in order that the cassettes 5 cannot tilt during the horizontal movement in the compartments 4. The entire magazine 3 can be raised and lowered by lifting spindles 22, in order to position a specific compartment 4 at the height of the loading opening 6 or the transfer opening 9. The lifting spindles 22 can be constructed as recirculating ball drives 22, which act on both sides approximately at the center of gravity of the magazine 3. Guides disposed beside the recirculating ball drive 22 are able to absorb the tilting moment (not illustrated in FIG. 2). The recirculating ball drives 22 can be connected to a drive via a non-illustrated common toothed belt.

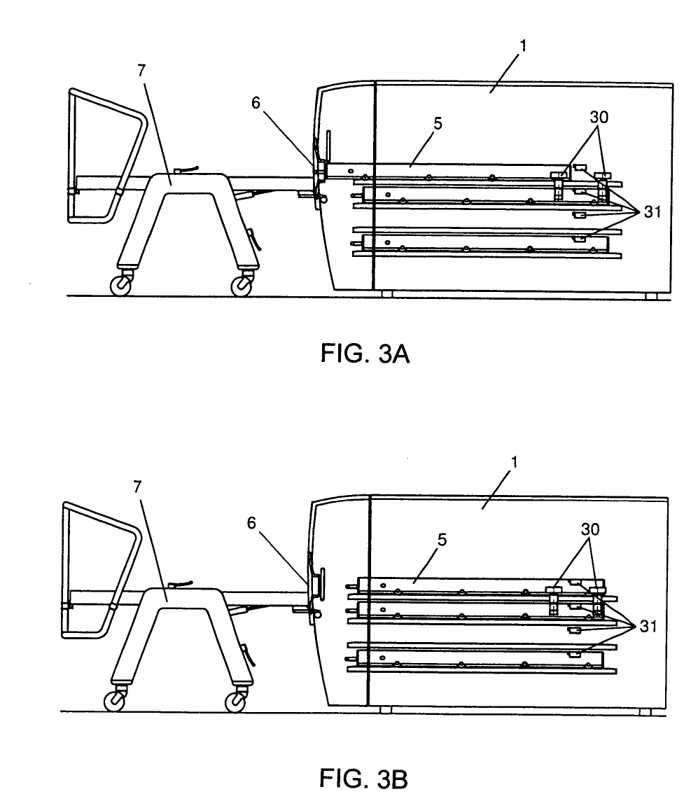

FIGS. 3A and 3B illustrate two different phases of loading a free compartment 4, here the topmost compartment, of the multi-cassette loader 1 with a new cassette 5. FIG. 3A shows the state in which the operator has pushed the cassette 5 from the transport trolley 7 through the loading opening 6 into the multi-cassette loader 1 to such an extent that its rear end comes into the engagement region of a friction drive 30. Using a non-illustrated sensor, the fact that the cassette 5 has been pushed in sufficiently far for this purpose is detected. The friction drive 30 has two driven friction wheels in this case, which are folded with a defined force against the side wall of the cassette 5. Provided in the side walls of the magazine 3 are appropriate cutouts, through which the friction drive 30 can be folded against the side walls of the cassette 5. By rotation of the friction wheels, the cassette 5 is drawn completely into the multi-cassette loader 1. This state is shown in FIG. 3B. The friction drive 30 is preferably provided on both sides of the cassette 5 in each case, and the cassette 5 is moved at the same time by both friction drives 30. Using two sensors, which are mounted in the multi-cassette loader 1 on the movement plane for the cassettes 5, that is to say on the plane in which the loading opening 6 and the transfer opening 9 are also located, it is detected whether the cassette 5 has already been drawn in completely. For this purpose, the sensors are mounted at a distance from each other that is somewhat shorter than the cassette 5 is long. Only when both sensors “see” the cassette 5 is it in the correct horizontal position, that is to say completely loaded. The sensors used are preferably light barriers but other sensor concepts can also be used, for example proximity sensors acting capacitively or inductively.

Each compartment 4 of the magazine 3 is assigned a spring force brake 31 on both sides of the cassette 5, which presses a brake lining against a side wall of the cassette 5 via a spring force when the cassette 5 is not in engagement with the friction drives 30. As a result, the cassette 5 is prevented from rolling away. This is necessary since separate friction drives 30 are not assigned to each compartment 4. There are only two friction drives 30, which are mounted in the multi-cassette loader 1 at the height of the movement plane of the cassette 5, as are all the sensors. The spring force brakes 31 do not have their own drive either with which they are actuated. The spring force brakes 31 are coupled mechanically to the folding movement of the respective friction drive 30. When the friction drive 30 is folded against the cassette 5, by the folding movement, it simultaneously actuates a lever that releases the spring force brake 31 as long as the friction drive 30 is folded against the cassette 5. When the friction drive 30 is folded back, that is to say is not in engagement with the cassette 5, the brake lining is pressed against the cassette 5 by the spring force.

Since all the drives and sensors are disposed outside the magazine 3 in the housing of the multi-cassette loader 1 on the movement plane of the cassettes 5, the magazine 3 advantageously needs no electric connections and, as a result, is constructed particularly simply and economically.

When the cassette 5 is to be unloaded from the multi-cassette loader 1, it is moved by the friction drives 30 in the direction of the loading opening 6 to such an extent that the operator can grip it at a handle on the front side of the cassette 5, in order to pull it completely onto the transport trolley 7.

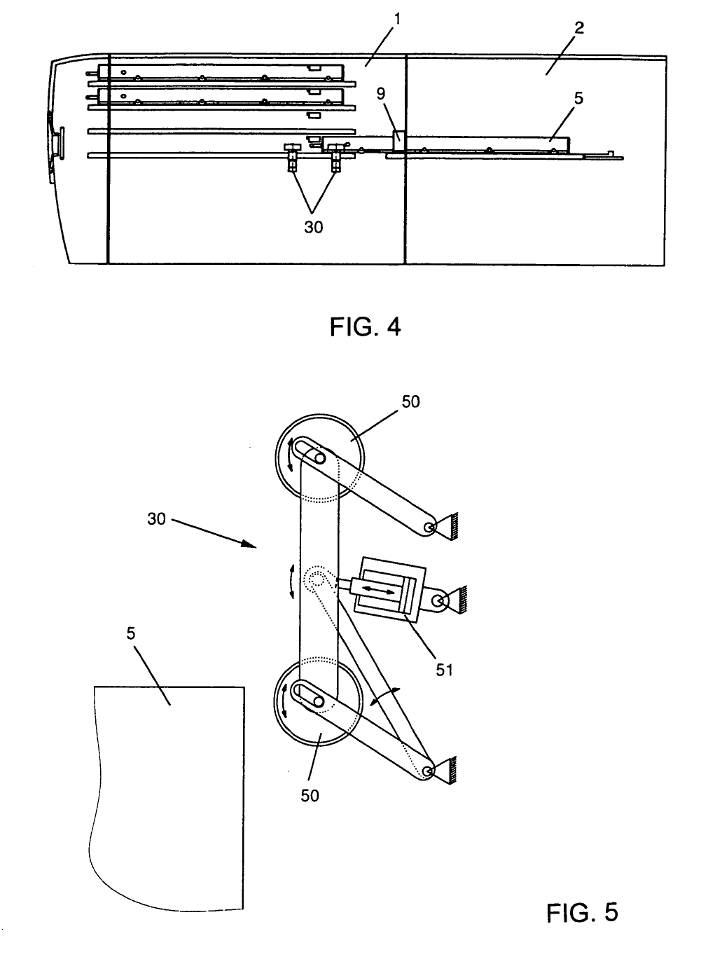

FIG. 4 shows a phase during the transfer of a cassette 5 from a compartment 4 of the multi-cassette loader 1, here from the lowest compartment, into the single-cassette loader 2. By use of the friction drives 30, the cassette 5 is pushed through the transfer opening 9 into the single-cassette loader 2 to such an extent that it is gripped by a non-illustrated transport drive of the single-cassette loader 2, which then draws it completely into the single-cassette loader 2. When, conversely, a cassette 5 is to be transferred from the single-cassette loader 2 to a free compartment 4 of the multi-cassette loader 1, the transport drive of the single-cassette loader 2 pushes the cassette 5 through the transfer opening 9 into the multi-cassette loader 1 to such an extent that it can be gripped there by the friction drives 30 and transported completely into the multi-cassette loader 1.

FIG. 5 shows a preferred embodiment of the friction drive 30 in a view from above. The friction drive 30 has two friction wheels 50, which are connected by connecting plates in such a way that they form a rocker. Since the cassettes 5 for loading the single-cassette loader 2 have to be transported a further distance than the cassettes 5 themselves are long, two friction wheels 50 are needed on each cassette side, which are fitted at a specific horizontal distance from each other. In the preferred embodiment, both friction wheels 50 each have a dedicated drive motor. A pneumatically acting actuator 51, which acts on the connecting plate between the friction wheels 50, presses the friction wheels 50 against the side wall of the cassette 5. Here, the freedom of movement of the friction wheels 50 is restricted by the connecting plates of the rocker to such an extent that, if a friction wheel 50 is no longer touching the cassette 5, the respective other friction wheel 50 is still pressed against the cassette 5 with a sufficiently high force. In an alternative embodiment of the friction drive 30, it is also possible for only one friction wheel 50 to be driven, the other friction wheel 50 being driven by the first friction wheel 50 at the same time by a toothed belt or by gears. Furthermore, use could also be made of a friction belt that runs over at least two wheels and is pressed against the cassette 5.

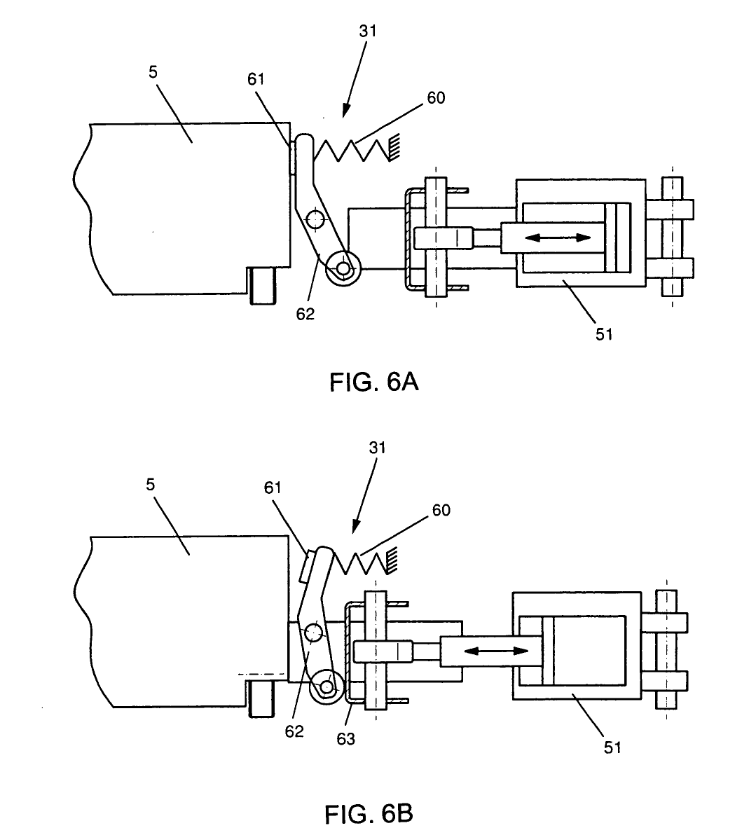

FIGS. 6A and 6B show the actuation of the spring force brake 31 by the actuator 51 which folds the friction drive 30 against the cassette 5. FIG. 6A shows the state in which a spring 60 of the spring force brake 31 presses a brake lining 61 against the cassette 5 via a lever 62 and blocks the cassette 5 as a result. FIG. 6B shows the state in which a control edge 63 of the actuator 51 presses against the lever 62 when the friction drive 30 is folded against the cassette 5 and, as a result, releases the brake lining 61 from the cassette 5.

This application claims the priority, under 35 U.S.C. § 119, of German patent application No. 10 2004 020 693.7, filed Apr. 28, 2004; the entire disclosure of the prior application is herewith incorporated by reference.

1. A method for providing and transferring cassettes for printing plates to a device for removing the printing plates from a respective cassette, which comprises the steps of:
storing the cassettes in compartments disposed above one another in a magazine;
introducing and removing the cassettes into/from the magazine through a loading opening;
transferring the cassettes to the device for removing the printing plates through a transfer opening and being taken aback from there through the transfer opening;
moving the cassettes in a horizontal movement plane between the loading opening and the magazine and between the transfer opening and the magazine;
disposing the loading opening, the transfer opening and the horizontal movement plane at a same height; and
raising and lowering the magazine vertically until a desired cassette is in the horizontal movement plane.

2. The method according to claim 1, which further comprises moving the cassettes horizontally by use of a friction drive.

3. The method according to claim 2, which further comprises blocking the cassettes in the compartments using a spring force brake.

4. The method according to claim 3, which further comprises releasing the spring force brake by activating the friction drive.

5. An apparatus for providing and transferring cassettes for printing plates to a device for removing printing plates from a respective cassette, the apparatus comprising:
a magazine having compartments disposed one above another for storing the cassettes;
a loader having a loading opening formed therein for introducing the cassettes into said magazine and for removing the cassettes from said magazine, said loader further having a transfer opening formed therein for transferring the cassette to and from the device for removing the printing plates, a horizontal movement plane for movement of the respective cassette between said loading opening and said magazine and between said transfer opening and said magazine being defined, said loading opening, said transfer opening and said horizontal movement plane being disposed at a same height; and
a lifting device for vertically positioning said magazine until a desired cassette is in said horizontal movement plane.

6. The apparatus according to claim 5, further comprising a friction drive for horizontally moving the respective cassette disposed in the horizontal movement plane.

7. The apparatus according to claim 6, wherein said friction drive contains connecting plates and two friction wheels connected by said connecting plates.

8. The apparatus according to claim 6, wherein said friction drive has a pneumatic actuator with which said friction drive is folded against the respective cassette.

9. The apparatus according to claim 8, further comprising a spring force brake for blocking the respective cassette in said compartments.

10. The apparatus according to claim 9, further comprising a lever disposed on said spring force brake, and through said lever said pneumatic actuator of said friction drive releases said spring force brake.

11. The apparatus according to claim 5, wherein said lifting device includes driven lifting spindles.
